(19) United States
(12) Patent Application Publication
(10) Pub. No.: US 2003/0072213 A1
(43) Pub. Date: Apr. 17, 2003

(54) Flash mixer

(76) Inventor: Skender Cocoli, Falls Church, VA (US)

Correspondence Address: Skender Cocoli, 7754 New Providence Dr. #22, Falls Church, VA, 22042-4497, US

(21) Appl. No.: 09/949,397

(22) Filed: Sep. 7, 2001

(51) Int. Cl. B01F 5/04

(52) U.S. Cl. 366/173.1

(57) ABSTRACT

A hydrodynamical dispersive flash mixing system with six pressured water jets and one nozzle for the injection of aluminum sulfate solution. The flash mixer, conceptually original, is highly recommended for medium, large, and extra large diameters of influent pipeline. The flash mixer introduced is very effective, flexible, reliable and cost savings. The flash mixer obtains an optimal coagulation, avoids clogging of pipes and nozzles with aluminum hydroxide scale, avoids the effects of water temperature, and controls the changes of flow capacity and coagulant dose. The hydrodynamical dispersive flash mixer with pressured water jets can be installed inside or outside the influent pipeline. One option is described for the installation of flash mixer inside the pipeline and three options for installing it outside the influent pipeline. Also, four alternatives are presented for the connection of the flash mixing system with the liquid chemical feed system.

### REFERENCES

| | | | |
|---|---|---|---|
| 09/634,009 | August 2000 | Cocoli | 210 |
| 4,152,262 | May 1979 | Rose | 210/136 |
| 4,248,713 | February 1981 | Meier | 210/232 |
| 4,331,542 | May 1982 | Emrie | 210/794 |
| 4,377,485 | March 1983 | Krofta | 210/704 |
| 4,441,997 | April 1984 | Fields | 210/266 |
| 4,468,320 | August 1984 | Schmidt | 210/97 |
| 4,482,461 | November 1884 | Hindnab, et. al. | 210/741 |
| 5,520,804 | May 1996 | Ward | 210/189 |
| 5,582,722 | December 1996 | Wachinski, et. al. | 210/189 |
| 5,804,062 | September 1998 | Wyness | 210/86 |
| 5,902,488 | May 1999 | Prince | 210/747 |
| 5,997,750 | December 1999 | Rozelle, et. at. | 210/744 |
| 6,013,181 | January 2000 | Thellmann | 210/266 |

### OTHER REFERENCES CONSULTED

Adin, A.; Rebhun, M. “Components of Deep-Bed Filtration Mathematical Model.” European Federation of Chemical Engineering. Symposium on Water Filtration, Antwerp, Belgium, April 1982.

American Society of Civil Engineers and American Water Works Association. Water Treatment Plant Design. 2nd Edition, McGraw-Hill Publishing Co., New York, N.Y., 1990.

American Water Works Association. Water Quality and Treatment. 1990.

Amirtharajah, A. “Optimum Backwashing of Sand Filters.” Journal of Environmental Engineering Division, American Society of Civil Engineers (ASCE), Vol. 104, no. 5, October 1978.

Amirtharajah, A. “Some Theoretical and Conceptual Views of Filtration.” Journal of American Water Works Association (AWWA), vol. 80, no. 12, December 1988.

Anonymous. “Water Filtration—The Mints-Ives Controversy 1960-73.” Filtration and Separation, Vol. 2, March/April 1976.

Arboleda V. J. “Hydraulic Control Systems of Constant and Declining Flow Rate in Filtration.” Journal of AWWA, vol. 69, no. 2, February 1974.

Artemenko, N. D. Oçisnji Stanci Dlja Patzjemnij Vodij na Tjumenshit. Vodosnabzhenije i Sanitarnaja Tehnika, no. 2, 1986.

Barret, M.J. “Aeration Studies of Weir Systems.” Water and Waste Engineering, Vol. 64, no. 9, September 1960.

Baylis, J. R. “Review of Filter Design and Methods of Washing.” Journal of AWWA, vol. 51, no. 11, November 1959.

Bollinger, K. A. “Water Treatment Plant Design is Flexible.” Water and Sewage Works, 30 April 1974.

Camp, T. R. “Theory of Water Filtration.” Journal of Sanitary Division, ASCE, p. 3, August 1964.

Chaudhry, F. H. “Theory of Declining Rate Filtration.” Journal of Environmental Engineering, Vol. 113, pp. 834-867, August 1987.

Cleasby, J. L. “Declining—Rate Filtration.” AWWA Journal. Vol. 73, no. 9, September 1981.

Cleasby, J. L. Arboleda, J.; Burns, D. E.; Prendiville, P. W; Savage, E. S. “Backwashing of Granular Filters.” Journal of AWWA, Vol. 69, no. 11, November 1977.

Cleasby, J. L. Di Bemardo, L. “Hydraulic Considerations in Declining Rate Filtration.” Journal of Environmental Engineering Division, ASCE, 1980.

Cleasby, J. L. Filter Rate Control Without Rate Controllers. Journal of AWWA, Vol. 61, no. 4, April 1969.

Cleasby, J. L. Williamson, M. W.; Baumann, E. R. “Effect of Filtration Rate Changes on Quality.” Journal of AWWA, Vol. 60, no. 4, p. 869, April 1968.

Cleasby, J. L., and Baumann, E. R. “Selection of Sand Filtration Rates.” Journal of AWWA, Vol. 54, no. 5, p. 579, May 1962.

Committee Report: Comparison of Alternative Systems for Controlling Flow Through Filters, AWWA Journal, vol. 76, no.1, January 1984.

Culp, R. L. “Direct Filtration.” AWWA Journal, Vol. 69, no. 7, July 1977.

Davis, S. N.; DeWiest, R. J. M. Hydrology. John Wiley & Sons, Inc., New York, 1966.

Degremont. Water Treatment Handbook, Vol. 1 and Vol. 2, 6th edition. Lavoisier Publishing, Paris, France 1991.

Diaper, E. W., Jr.: Ives, K. J. “Filtration Through Size-Graded Media.” Journal of Sanitary Engineering Division, ASCE, June 1965.

Droste, R. L. Theory and Practice of Water and Wastewater Treatment. John Wiley and Sons, Inc. New York, N.Y., 1997.

Environmental Protection Agency. Technologies for Upgrading Existing or Designing New Drinking Water Treatment Facilities. EPA/625/4-89/023.

Fair, G. M. and Geyer, J. C.; Okun, D. A. “Water and Waste Water Engineering.” Vol. 1. John Wiley & Sons, New York, N.Y., 1968.

Fair, G. M.; Geyer, J. C.; Okun, D. A. “Water and Waste Water Engineering.” Vol. 2. John Wiley & Sons, New York, N.Y., 1968.

Fox, D. M.; Cleasby, J. L. “Experimental Evaluation of Sand Filtration Theory.” Journal of Sanitary Engineering Division, ASCE, SA 5, October 1966.

Ghosh, M. M.; Jordan, T. A.; Porter, R. L. “Physicochemical Approach to Water and Waste Water Filtration.” Journal of Environmental Engineering Division, ASCE, 1975.

Gimbel, R. Theoretical Approach to Deep Bed Filtration. CRC Press, Inc., Boca Raton, Fla., 1989.

Heertjes, P. M.; Lerk, C. F. “The Function of Deep Bed Filters.” Institute of Chemical Engineering, T129, 1967.

Herzig, J. P.; LeClerc, D. M.; Le Goff, P. “Flow of Suspensions Through Porous Media—Application to Deep Bed Filtration.” Industrial Engineering Chemistry, 8, August 1970.

Hsuing, K.; Cleasby, J. L. “Prediction of Filter Performance.” Journal of Sanitary Engineering Division, ASCE, December 1968.

Huang, J Y. C.; Baumann, E. R. “Least Cost Sand Filter Design for Iron Removal.” Journal of Sanitary Engineering Division, ASCE, SA 2, April 1971.

Hudson, E. H. Water Clarification Processes. Van Nostrand Reinhold Co., New York, N.Y., 1981.

Hudson, E. H., Jr. “Physical Aspects of Filtration.” Journal of AWWA, Vol. 61, no. 3, March 1969.

Huisman, L; Wood, W. E. “Slow Sand Filtration.” World Health Organization, Geneva, 1974.

Hutchison, W. R.; Foley, P. D. “High-Rate Direct Filtration.” Journal of AWWA, Vol.68, no. 6, June 1976.

Hutchison, W. R.; Foley, P. D. “Operational and Experimental Results of Direct Filtration.” Journal of AWWA, Vol. 66, no. 2, February 1974.

Ives, K. J. “Rapid Filtration.” Water Resources, Vol. 4, 1970.

Ives, K. J. “Simplified Rational Analysis of Filter Behavior.” Proceedings of Institute of Civil Engineering, Vol. 25, 1963.

Ives, K. J. “Theory of Filtration.” International Water Supply Association, London, vol. 1, 1969.

Ives, K. J. Sholji, I. “Research on Variables Affecting Filtration.” Journal of Sanitary Engineering Division, ASCE, SA 4, August 1965.

Joshi, N. S., etc. Up and Downflow Filtration for Iron Removal from Groundwater. Department of Environmental Engineering, Copenhagen, Denmark, 1988.

Kawamura, S. Design and Operation of High Rate Filters, I, II, III, Journal of AWWA, October, November, December 1975.

Kawamura, S. Integrated Design of Water Treatment Facilities. John Wiley and Sons, Inc. New York, N.Y., 1991.

Kljaçko, V. A.; Apelcin, I. E. Oçistka Prirodnih Vod. Isdatjelstvo Literaturi Pastrajitelstvu, Moskva, 1971.

Knocke, W. R.; Conley, L. and Van Benschoten, J. E. “Impact of Dissolved Organic Carbon on the Removal of Iron During Water Treatment.” Water Research, vol. 26, November 1992.

Kulskij, L. A.; Goronovskij, I. T.; Koganovskij, A. M.; Shevçenko, M. A. Spravoçnik, po Svojstam Metodam Analiza i Oçistnje Vodi, Hankova Dumha, Kiev, 1980.

Lamarre, B. L.; McGarry, F. J.; Stover, E. L. Design, Operation and Results of a Pilot Plant for Removal of Contaminants from Ground Water.” Proceedings of the Third National Symposium on Aquifer Restoration and Groundwater Monitoring. National Eater Well Association, Worthington, Ohio. 1983.

Leva, M. Fluidization. McGraw-Hill Books Co., New York, N.Y., 1959

McGhee, T. J. Water Supply and Sewerage. 6th Edition, McGraw-Hill Publishing Company, New York, N.Y., 1991.

Mintz, D. M. “Modern Theory of Filtration.” Report to International Water Supply Association Eighth Congress, October 1966.

Mohanka, S. S.; “Multilayer Filtration of Suspensions.” Ph.D. Theses. University of London, UK, 1969.

Montgomery, J. M. Consulting Engineers, Inc. Water Treatment Principles and Design. John Wiley and Sons, New York, N.Y., 1985.

Mouchet, P. “From Conventional to Biological Removal of Iron and Manganese in France.” Journal of AWWA, vol. 84, pp. 158-167, April 1992.

Nitescu, S. “Alegerea schemelor de Deferizare si Demanganizare a Apei la Statiile se Tratare Mici.” Hidrotrhnica, vol. 18, no. 11, November 1973.

Sakthivadival, R.; Thanikachalam, V.; Seetharaman, S. “Head-Loss Theories in Filtration.” Journal of AWWA, Vol. 64, no.2, February 1972.

Sanks, R. L. Water Treatment Plant Design. Ann Arbor Science Publishers, Ann Arbor, Michigan, 1982.

Saravanamuthu, V.; Ami, R. B. Overview of Deep Bed Filtration: Different Types and Mathematical Models for Water, Wastewater, and Sludge Filtration. CRC Press, Inc., Boca Raton, Florida, 1989.

Tesarik, I. “Flow in Sludg—Blanket Clarifiers.” Journal of Sanitary Engineering Division, Vol. 93, No. SA6, December, 1967.

Viessman, W. Jr.; Hammer, M.J. Water Supply and Pollution Control. 5th edition. Harper Collins, NewYork, N.Y., 1993.

Vigneswaran, S.; Aim, R. B. Overview of Deep Bed Filtration: Different Types and Mathematical Models for Water, Wastewater and Sludge Filtration. CRC Press Inc., Boca Raton, Florida, 1989.

Visscher, J. T. etc. “Slow Sand Filtration: Design, Operation and Maintenance.” Journal of AWWA, Vol. 82, no. 6, June 1990.

Yao, K. M. “Water and Wastewater Filtration: Concepts and Applications.” Environmental Science and Technology, Vol. 5, 1971.

Zirschky, J.; Carlson, L. “Overland flow for Iron Removal from Potable Water.” Journal of AWWA, Vol. 96, January 1984.

### BACKGROUND OF THE INVENTION

The present invention relates to drinking water purification systems, and more specifically to a flash mixing system.

Effectiveness of coagulation process depends upon the product of velocity gradient with residence time—the dimensionless number G·t. The water temperature, the flow plant, and the quality of raw water can change continually. The dissipation energy and the alum dose for an optimal coagulation process should be changed in accordance with these changes. All factors that have influence over the coagulation process are interrelated. An optimal coagulation will have important effect over flocculation and other pre-treatment processes.

The hydrodynamical dispersive flash mixer with pressured water jets, with seven nozzles—six for hydrodynamical dispersion of coagulant and one for injection of chemical solution—is conceptually original and an optimal solution especially for medium, large, and extra large diameters of influent pipeline.

The primary initial conditions for an optimal hydrodynamical dispersion of coagulant are the mean velocity of the jet exit, the geometry of the exit, and the discharge. Secondary initial conditions are the intensity of water turbulence in pipe and the distribution of the velocity in cross section of the flow in pipe. Hydrodynamical dispersion and molecular diffusion are included in one parameter.

### BRIEF SUMMARY OF THE INVENTION

The present invention relates to the flash mixing process. The hydrodynamical dispersive flash mixer with six pressure water jets and one nozzle for chemical solution injection, based on countercurrent principle, is an optimal system, conceptually original, which optimizes both, the process and the total cost. This flash mixing system is especially recommended for medium, large, and extra large diameters of influent pipeline. The flash mixer is also highly recommended because it avoids clogging of pipes and nozzles with aluminum hydroxide scale, and, the effects of water temperature, flow capacity and coagulant dose changes are under control. Alum is the most used coagulant because of its availability and low cost, and easy to use and easy to storage characteristics.

For the existing systems EPA—Technologies for Upgrading Existing or Designing New Drinking Water Treatment Facilities (Mar. 25, 1990) states “the primary disadvantages are that the orifices in the injection pipe tend to become plugged and the mixing intensity cannot be varied.” Susumu Kawamura in his book Integrated Design of Water Treatment Facilities (1990:75) maintains “one disadvantage of this alternative is the potential for coagulant and debris present in pumped water to clog the nozzles. A second disadvantage is the difficulty in applying it to a system with extra large pipes or channels.” According to Kawamura (1990:87) “. . . the strength of the alum solution should be greater than 1%, upstream of the injection nozzle, and the pH of the solution should be less than 3.0.”

For systems with only one injection nozzle for dissipation energy in the mixing zone and for discharging alum solution it is impossible to control the value of the dimensionless number G·t vis-ä-vis changes of plant flow, water temperature and coagulant dose. It is also impossible to maintain the recommended value of strength of the alum solution and pH.

The coagulation process realized in systems with one common nozzle for mixing and alum solution injection especially for medium, large, and extra large diameters will not be as effective as the hydrodynamical dispersive flash mixer with six pressured water jets and one nozzle for the injection of alum solution. This invention, which incorporates a liquid chemical feed system, with metering pump, presented in four alternatives as described in this document has great advantages in controlling the recommended values of strength of the alum solution and pH of the solution.

Water Treatment Plant Design (1998:84) maintains that “a valve installed in the pump discharge line can control pumping rate and vary energy input for various plant flows and types of coagulating chemicals.” Water treatment processes should be designed by Q_{max·day} (flow rate for maximum day). It is very probable that plant flows during the year be reduced from Q_{max·day} to Q_{min·day} with a ratio 1:6. Based on calculations for this range of flow change, the value of velocity gradient will change from G for Q_{max·day} to 0.0632·G for Q_{min·day}. By a flow regulating valve installed in the discharge side of pump, the valve of velocity gradient can be maintained constant, for one nozzle system, for Q_{max·day} and Q_{min·day}. But the value of residence time will increase 6 times for Q_{min·day}=⅙·Q_{max·day} for installation in-line. The dimensionless number G·t will change six times and the effectiveness of coagulation process cannot be controlled by one nozzle system.

Water Treatment Plant Design (1998:94) maintains “Instead of a single orifice directed upstream or downstream with the flow, [the] design uses multiple jets that inject perpendicular to the flow in pipe.” This system is very similar to the one nozzle system. The hydrodynamical dispersive flash mixer with six pressured water jets separately controlled and with one nozzle for the injection of alum solution, conceptually original, optimizes the process and the total cost.

The new system can obtain a value for the dimensionless number G·t=400 to 1600. The range of mean velocity of the jets exit is recommended 4-10 m/sec. The length of mixing zone is 1.15 Dₚ (Dₚ being the diameter of influent pipeline). The discharge coefficient of nozzles is recommended 0.82. For six nozzles with C=0.82 and t=10° C., the value of velocity gradient and residence time should be calculated by the following formulas:

$$G = 1419 \cdot \frac{{V}_{j}}{{D}_{p}} \cdot \sqrt{\frac{{V}_{j}}{{D}_{p}} \cdot a} \qquad ( 1 )$$

$$t = \frac{{Q}_{d}}{0.9 \cdot {D}_{p}^{3}} \qquad ( 2 )$$

where

G=velocity gradient, [1/sec]

Vⱼ=mean velocity of jet exit, [m/sec]

Dₚ=diameter of pipe, [m]

a=area of nozzle's orifice, [m²]

t=residence time, [sec]

Q_{d}=designed flow capacity of water treatment plant, [m³/sec]

The velocity gradient in mixing zone, based on the intensity of turbulence, should be calculated by the following formula:

$$G = 2553 \cdot \sqrt{\frac{{V}_{p} \cdot {h}_{{w}_{p}}}{{D}_{p}}} \qquad ( 3 )$$

where

Vₚ=velocity of water in pipe, [m/sec]

Dₚ=diameter of pipe, [m]

h_{w}_{ₚ}=hydraulic losses in the length of mixing zone, [m]

The strength of alum solution, directed upstream the injection nozzle is recommended to be 1-15%.

The hydrodynamical disperse flash mixer with six pressured water jets and one injection nozzle for alum solution should be integrated with liquid chemical feed system. In this invention, four alternatives are presented for such integration.

Alternative 1

In the liquid chemical feed system, alum solution should be prepared with 15% strength. In relation to the changes of flows in water treatment plant and doses of coagulants, alum solution flows with 15% strength (L/min) are discharged upstream the injection nozzle for a second dilution. The strength of alum solution in second dilution will change from 1 % to 15%, to fit the changes of plant flows and doses of coagulant. The calculation of flow from liquid chemical feed system, with metering pump, and from flash mixing system for second dilution should be respectively calculated by following formulas:

$${q}_{c} = [ \frac{{Q}_{f} \cdot {D}_{f}}{{Q}_{p r} \cdot {D}_{max}} ] \cdot 4.32 ( 0.00406 \cdot {Q}_{p r} \cdot {D}_{max} ) \qquad ( 4 )$$

q_{w}=(4.32=28.8·Cₛ)·(0.00406·Qₚᵣ·Dₘₐₓ) (5)

$${C}_{s} = \frac{{Q}_{f} \cdot {D}_{f}}{{Q}_{p r} \cdot {D}_{max}} \cdot 0.15 \qquad ( 6 )$$

where

q_{c}=pumping rate of alum solution with 15% strength, [L/min]

q_{w}=rate of flow from flash mixer, upstream of injection, for second dilution, [L/min]

cₛ=chemical strength

Qₚᵣ=designed capacity of water treatment plant, [MGD]

Dₘₐₓ=designed maximum dose of coagulant, [mg/L]

Q_{f}=real flow that enters in water treatment plant, [MGD], Q_{f}<Qₚᵣ

D_{f}=real dose of coagulant, [mg/L], D_{f}<Dₘₐₓ

The rate of flow after second dilution, discharged by injection nozzle is:

qₛ=q_{c}+q_{w} [L/min] (7)

Alternative 2

In the liquid chemical feed system, alum solution should be prepared with 15% strength and a second dilution should be performed. The strength of alum solution will change within the range of 1% to 15%, in accordance with the changes of plant flows and dose of coagulant, maintaining the value of qₛ=q_{c}+q_{w} constant. By the metering pump, this flow will be discharged upstream of the injection nozzle. The calculation of flows q_{c} and q_{w} should be performed by formulas (4), (5), and (6). For Alternative 2, the rate of flow q_{w} should be taken from utility water, within the area of liquid chemical feed system and will be discharged in the discharge side of metering pump.

Alternative 3

Within the area of liquid chemical feed system, should be prepared the alum solution with preselected strength from 1 % to 15% and by metering pump the flow should be discharged upstream of the injection nozzle, accordingly with the changes of plant flows and dose of coagulant. The value of flow qₛ will not be constant.

Alternative 4

From liquid chemical storage of commercial liquid alum, that contains 5.4 lb dry alum per gallon, is taken the flow q_{c}, and by metering pump it is discharged upstream the injection nozzle where the dilution with 15% strength is performed with filtered water q_{w} from flash mixing system. Flows q_{c}, q_{w}, and qₛ should be calculated with the following formulas:

q_{c}=0.02707·Cₛ·Qₚᵣ·Dₘₐₓ (5)

q_{w}=(4.32−6.667·Cₛ)·0.00406·Qₚᵣ·Dₘₐₓ (9)

where

$${q}_{s} = {q}_{c} + {q}_{w} , {C}_{s} = \frac{{Q}_{f} \cdot {D}_{f}}{{Q}_{p r} \cdot {D}_{max}} \cdot 0.15 ,$$

Qₚᵣ, Dₘₐₓ are the same as for

(4), (5), and (6).

The hydrodynamical dispersive flash mixer optimizes both the coagulation process and the total costs. This flash mixing system is recommended for water treatment plants where alum is the main coagulant. This system is particularly recommended for medium, large, and extra large diameters of inflow pipeline. Since the direct filtration process is very sensitive to optimal coagulation, the hydrodynamical dispersive flash mixer, with six pressured water jets and one nozzle for injection of chemical solution, is highly recommended.

### BRIEF DESCRIPTION OF THE SEVERAL VIEWS OF THE DRAWINGS

The present invention is illustrated by the embodiments shown in the drawings, in which:

FIG. 1 is the hydrodynamical dispersive flash mixer with six pressured water jets and one nozzle for the injection of chemical solution.

FIG. 2 is a schematic representation of a cross-section of flash mixer installed in vertical position.

FIG. 3 is a plan, schematic representation, of cross-sections of FIG. 2 through a-a and b-b.

FIG. 4 is a schematic representation of a cross-section of flash mixer installed in vertical position, when the source of the pressured water is main transmission of filtered water or pumped process water.

FIG. 5 is the hydrodynamical dispersive flash mixer with six pressured water jets and one nozzle for the injection of chemical solution, as a second option.

FIG. 6 is a schematic representation of a cross-section of flash mixing system installed in horizontal position, when the source of the pressured water is main transmission of filtered water with or without pump.

FIG. 7 is a schematic representation of a cross-section of flash mixing system installed in vertical position but the nozzles are turned by 90% in the direction of influent pipeline.

FIG. 8 is a schematic representation of a cross section of flash mixing system installed in the influent pipeline.

FIG. 9 is a schematic representation of a cross-section of FIG. 8 through A-A.

FIG. 10 is a schematic representation of a cross section of flash mixer installed in vertical position for alternatives 1 and 4, as a first option.

FIG. 11 is a schematic representation of a cross section of flash mixing system installed in vertical position for alternative 1 and 4, as a second option.

FIG. 12 is a generalized graph for preliminary engineering evaluation of the flash mixing system.

### DETAILED DESCRIPTION OF THE INVENTION

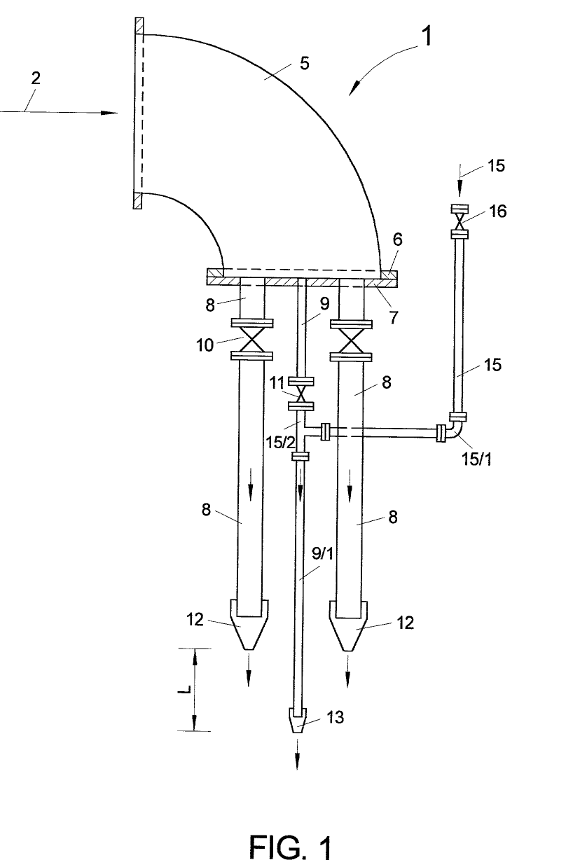

FIG. 1 shows the hydrodynamical dispersive flash mixer with six pressured water jets and one nozzle for the injection of alum solution. The source of pressured water is pipeline 2, which is a branched pipe from main transmission of drinking water with or without a booster pump. For the vertical installation of the flash mixer, it is foreseen a 90°- elbow 5, with flanged ends. At flange 6 of elbow 5 is fixed the flange 7 where six pipes 8 and one pipe 9 are installed. In each of the pipes 8 is installed an electric isolation valve by remote control 10. In pipe 9 is installed an electric isolation valve 11. In each of the pipes 8 is installed a nozzle 12 for pressure water jets and in pipe 9/1 a nozzle 13 for injection of alum solution. Alum solution from liquid chemical feed system with metering pump is supplied by pipeline 15 to the flash mixer. Pipeline 15 discharges alum solution in pipe 9/1 with or without a second dilution in pipe 9/1. In pipeline 15 is installed an isolation valve 16. By nozzles 12, based on the value of mean velocity at orifice and flow through nozzles, is obtained the required power for dispersion of coagulant in a very short time in mixing zone volume. By nozzles 13, installed in front of nozzles 12 in a distance L, is injected alum solution. The system of pipes 8, 9, and 9/1 is fixed by a special construction 22. The hydrodynamical dispersive flash mixer 1, with six pressured water jets and one nozzle for the injection of alum solution, will be manufactured as required in each project.

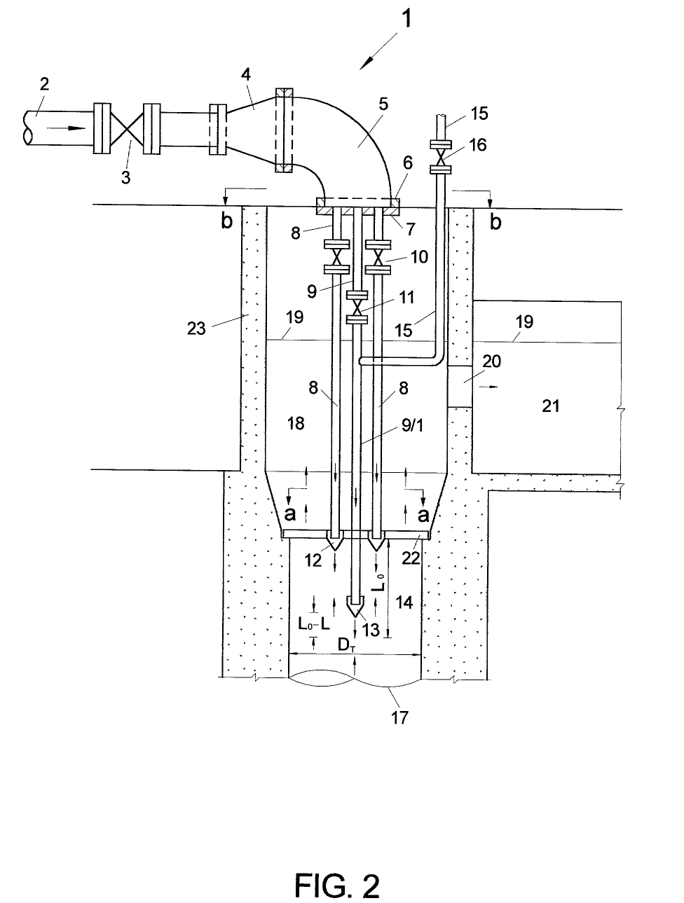

FIG. 2 shows vertical installation of flash mixer 1. The source of pressured water is pipeline 2, which is branched pipe from main transmission of drinking water with or without booster pump. To satisfy the requirements of installation, operation, and maintenance isolation valve 3 and reducer 4 are installed. Pressured water runs to 90° -elbow 5, which serves as a distributor for pipes 8 and 9. To 90°-elbow 5 is fixed flange 7 where six pipes 8 and one pipe 9 are installed. At each pipe 8 an electric isolation valve 10 by remote control is installed. An electric isolation valve 11 by remote control is also installed in pipe 9. In each pipe 8 is installed a nozzle 12 for pressure jets and in pipe 9/1 a nozzle 13 for injection of alum solution. Alum solution from liquid chemical feed system with metering pumps is supplied by pipeline 15 to the flash mixer. Pipeline 15 discharges alum solution in pipe 9/1 with or without a second dilution in pipe 9/1. An isolation valve 16 is installed in pipeline 15. Pressured water runs from 90°-elbow 5 to pipe 9 to realize a second dilution of alum solution in pipe 9/1 and by nozzle 13 this solution is discharged in mixing zone inside influent pipeline 17 in a distance L in front of nozzles 12. After flash mixing, the flow is conveyed into chamber 18 with maximum water level 19. From chamber 18, plant flow goes through orifice 20 to flocculation basin 21.

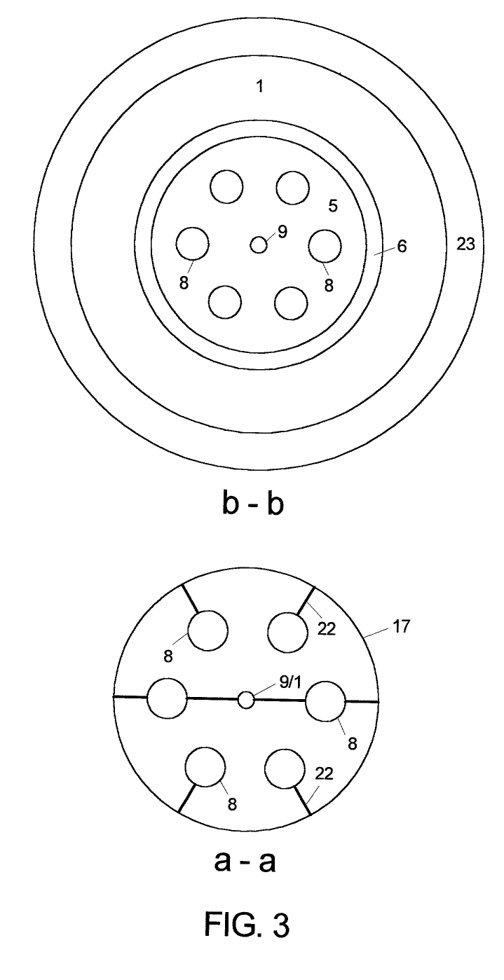

FIG. 3 shows the cross-sections of FIG. 2 through a-a and b-b. The flash mixer 1 is installed inside the hydraulic structure 23. Pipes 8, 9, and 9/1 are fixed upstream nozzles 12 by a special metallic structure 22.

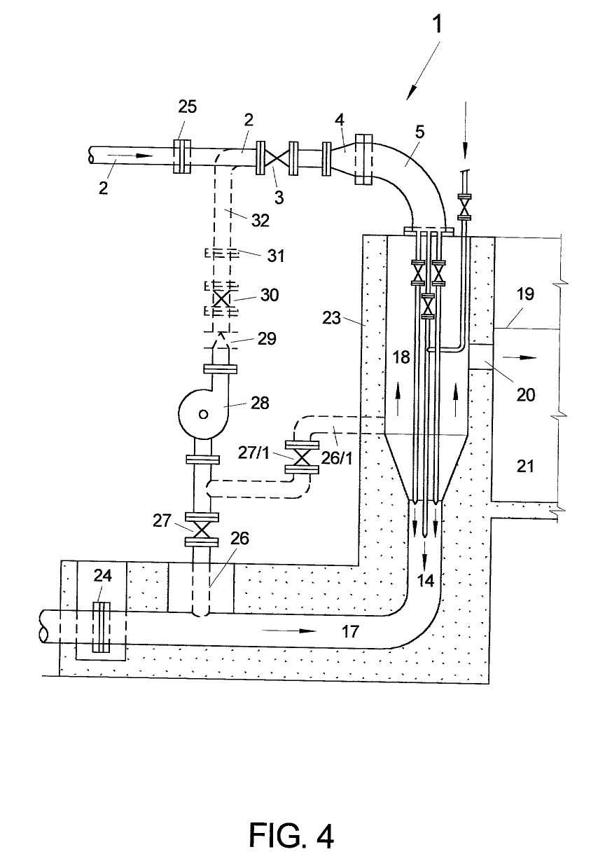

FIG. 4 shows vertical installation of flash mixer 1. The source of pressured water is pipeline 2, which is branched from main transmission of drinking water with or without booster pump. In similar cases, as a second option, the source of pressured water will be pump 28, which is supplied by suction pipe 26. Pipe 26 is supplied by influent pipeline 17. An additional pipe 26/1 may be included as a suction pipe of pump 28, which is activated when isolation valve 27 is closed. The discharge pipe 32 of pump 28 will supply pressured water in 90-elbow 5, which serves as a distributor for six pipes 8, and pipes 9 and 9/1 where nozzles 12 and 13 are installed. The nozzles 12 are installed in the exit of mixing zone 14, but nozzle 13 is installed in the entrance of mixing zone or in an intermediate position, which depends on the project requirements. From mixing zone 14 water flow is directed to chamber 18 and through orifice 20 to flocculation chamber 21 with water level 19.

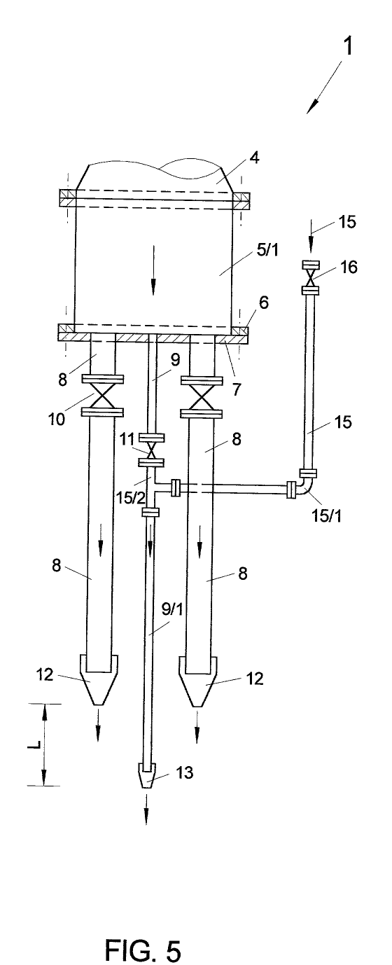

FIG. 5 shows the hydrodynamical dispersive flash mixer 1 with six pressured water jets and one nozzle for injection of alum solution. FIG. 5 is the same as FIG. 1 but instead of 90°-elbow 5 is installed a cylindrical piece of pipe 5/1, which also serves as a distributor for six pipes 8 and pipe 9.

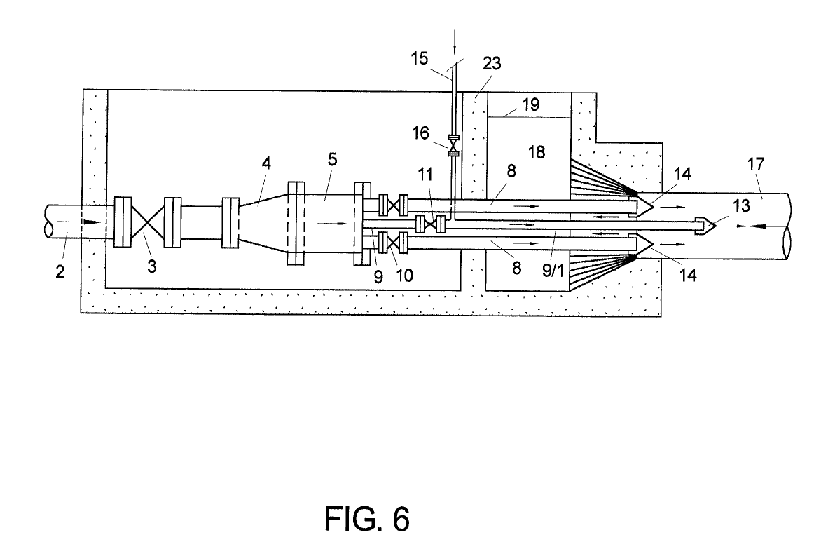

FIG. 6 shows horizontal installation of flash mixing system 1, given in FIG. 5. The description of this figure is the same as FIG. 4 and 5.

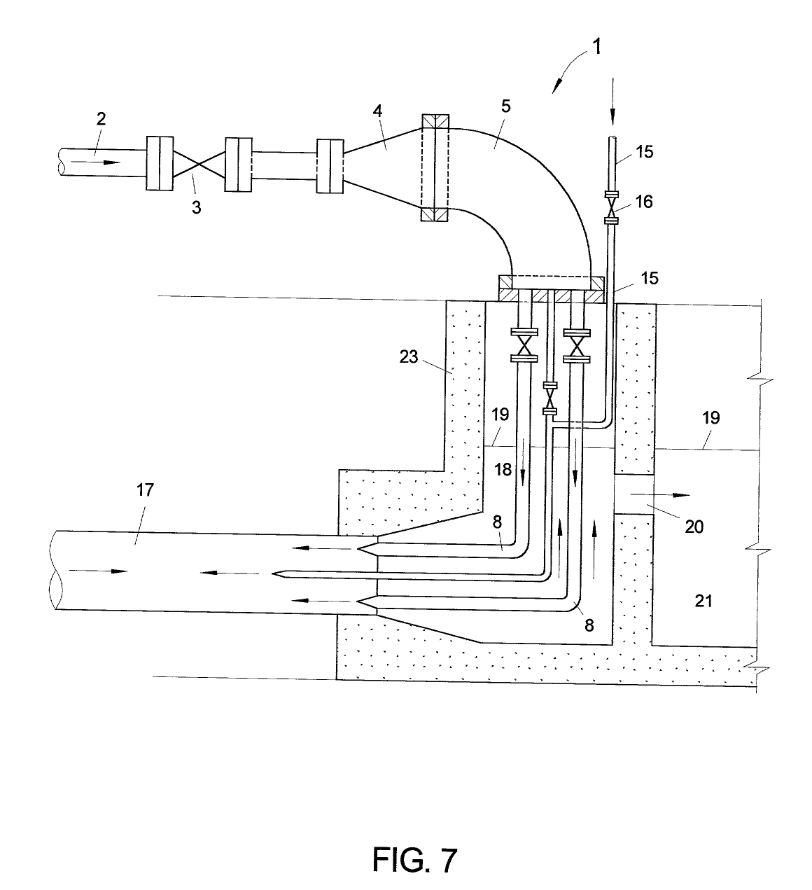

FIG. 7 shows vertical installation of flash mixer 1. FIG. 7 is the same as FIG. 4 but pipes 8 and 9/1 are bent 90° to fit with inflow pipeline 17.

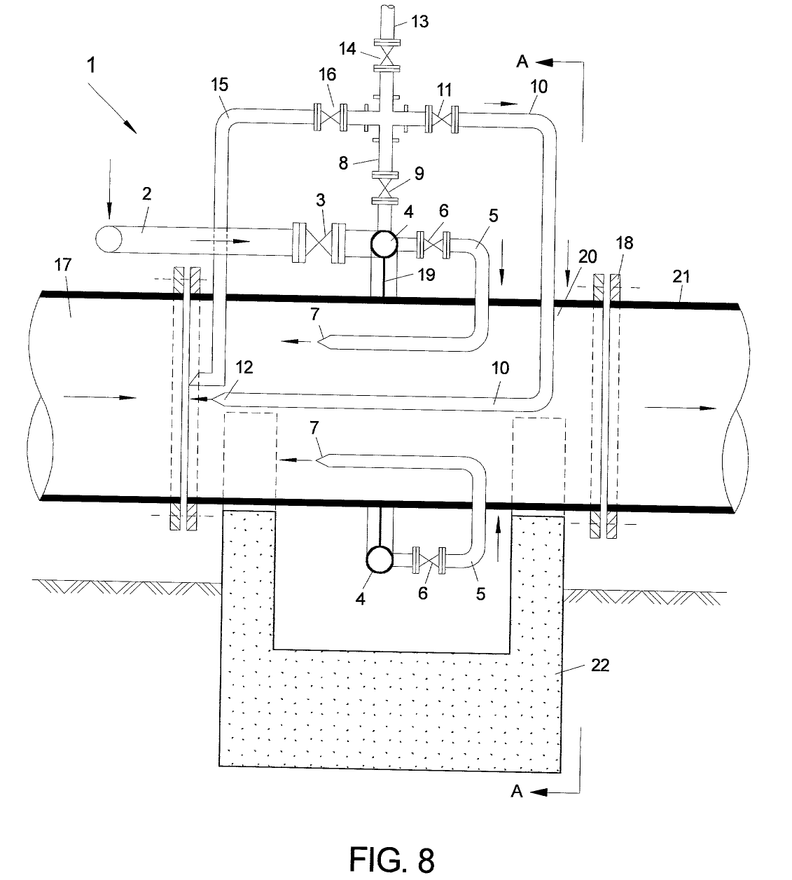

FIG. 8 shows a cross-section of flash mixing system 1, installed in influent pipeline 17. The source of pressured water is pipeline 2, which is branched from main transmission of drinking water with or without a booster pump. Pipeline 2 supplies the ring pipe 4, which has the same diameter as pipe 2. From ring pipe 4 are branched six pipes 5 and pipe 10, in which are installed nozzles 7, for pressure water jets and nozzle 12 for injection of alum solution, respectively. Alum solution from chemical feed system with metering pump is supplied by pipeline 13. From pipeline 13 are branched pipe 10 for normal operation and pipe 15 for emergency conditions. In each pipe 5 is installed an electric isolation valve 6, by remote control. In pipe 10 is also installed an electric isolation valve 11 by remote control. The ring pipe 4 is attached to pipe 20 by a special metallic structure. The hydrodynamical dispersive flash mixer 1 with pressured water jets is installed within pipe 20 with flanged ends 18, which together are integral parts of the flash mixing system. By pipe 8 is supplied a small quantity of pressured water for a second dilution or for flushing. FIG. 8 shows flash mixing system for alternatives 2 and 3 of liquid chemical feed system.

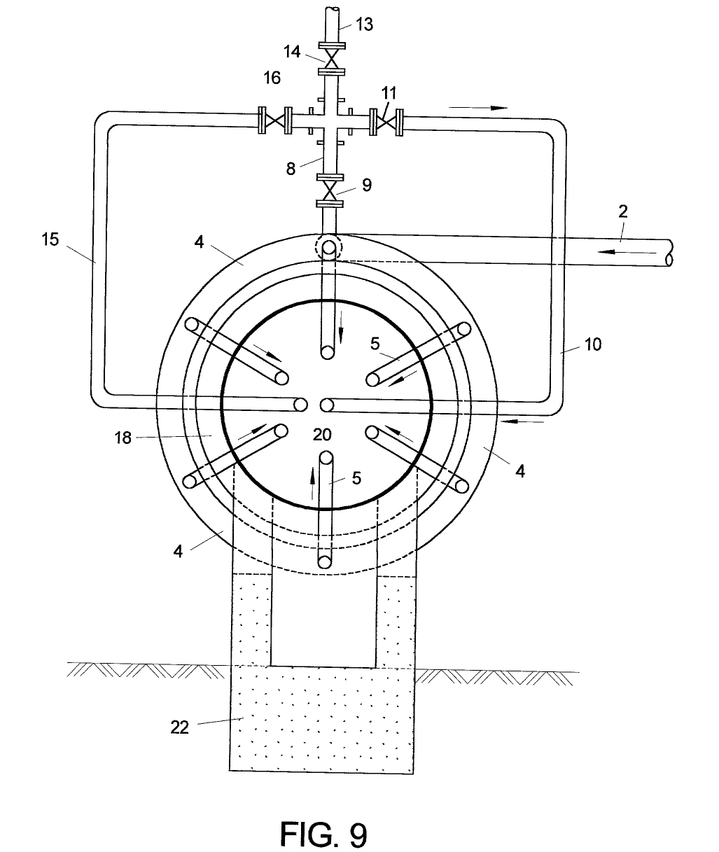

FIG. 9 shows a cross-section of FIG. 8 through A-A. The source of pressured water is pipeline 2, which is branched from main transmission of drinking water with or without a booster pump. Pipeline 2 supplies the ring pipe 4. From ring pipe 4 are branched six pipes 5 and pipe 8, which supplies pipe 10 with small water flows for normal operation and pipe 15 for emergency conditions. Through pipe 13 is supplied alum solution from liquid chemical feed system, which supplies pipe 10 for normal conditions and pipe 15 for emergency conditions. The flash mixer 1 is supported by a concrete structure 22. FIG. 9, as a cross-section through A-A of FIG. 8, shows the flash mixer, for alternatives 2 and 3 of liquid chemical feed system.

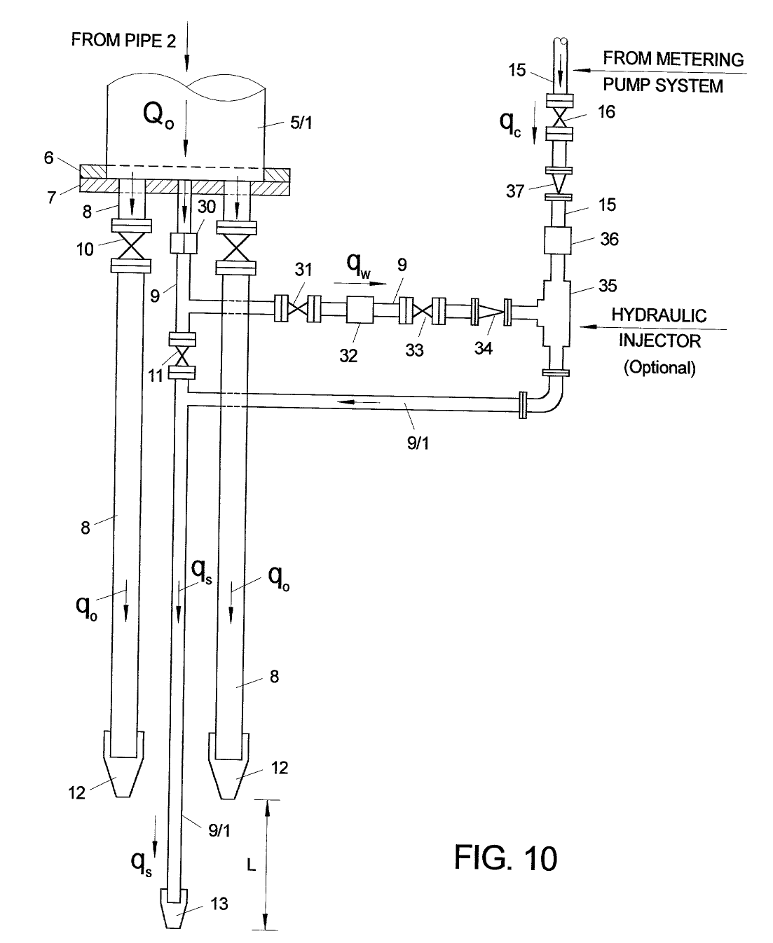

FIG. 10 shows the hydrodynamical dispersive flash mixer 1 with six pressured water jets and one nozzle for injection of alum solution, to be installed in vertical position. The connection of liquid chemical feed system with flash mixer will be realized in alternatives 1 and 4. According to these alternatives a second dilution of alum solution will be performed in pipe 9/1. The source of pressured water is pipeline 2, which is branched from main transmission of drinking water with or without a booster pump. For vertical installation of flash mixing system is used a cylindrical piece of pipe 5/1 with flanged ends, the same as in FIG. 5. At flange 6 of 5/1 is fixed flange 7 where are installed six pipes 8 and one pipe 9. In each of pipes 8 is installed an electric isolation valve 10, by remote control. In pipe 9 is installed an isolation valve 11 and pressure control valve 30. Also, in pipe 9 are installed flow control valve 31, magnetic flow meter 32, isolation valve 33 and check valve 34. From liquid chemical feed system with metering pump the alum solution, which will have a second dilution, is supplied to hydraulic injector 35 through pipe 15. In pipe 15 are installed magnetic flow meter 36, check valve 37 and isolation valve 16. Alum solution diluted for the second time in hydraulic injector 35 will be conveyed to nozzle 13 by pipe 9/1. At the end of each pipe 8 will be installed nozzle 12. Nozzle 13 serves for injection of alum solution, and will be installed in front of 12 in distance L.

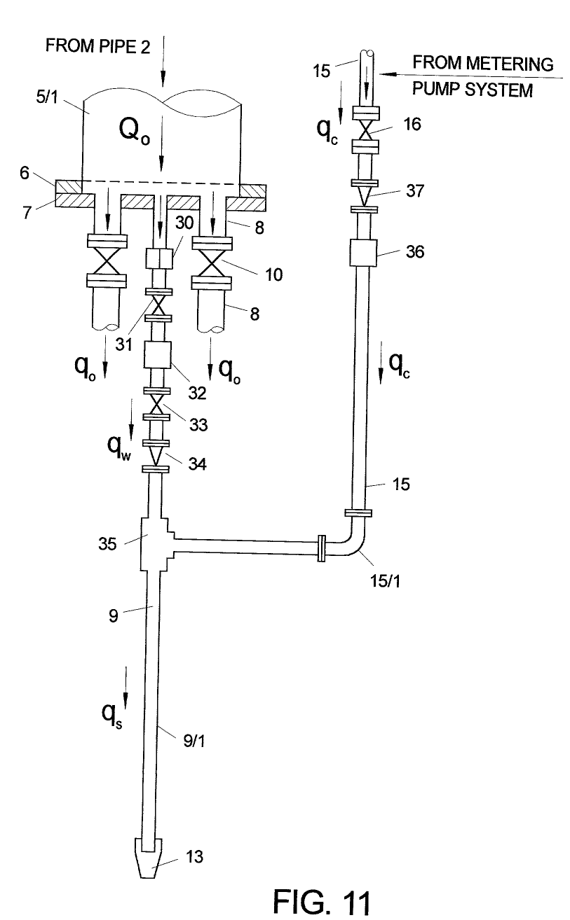

FIG. 11 shows the hydrodynamical dispersive flash mixer 1 with six pressured water jets and one nozzle for injection of alum solution, predicted to be installed in vertical position. The connection of liquid chemical feed system with the flash mixer will be realized according to alternatives 1 and 4. FIG. 11 shows a second option of FIG. 10.

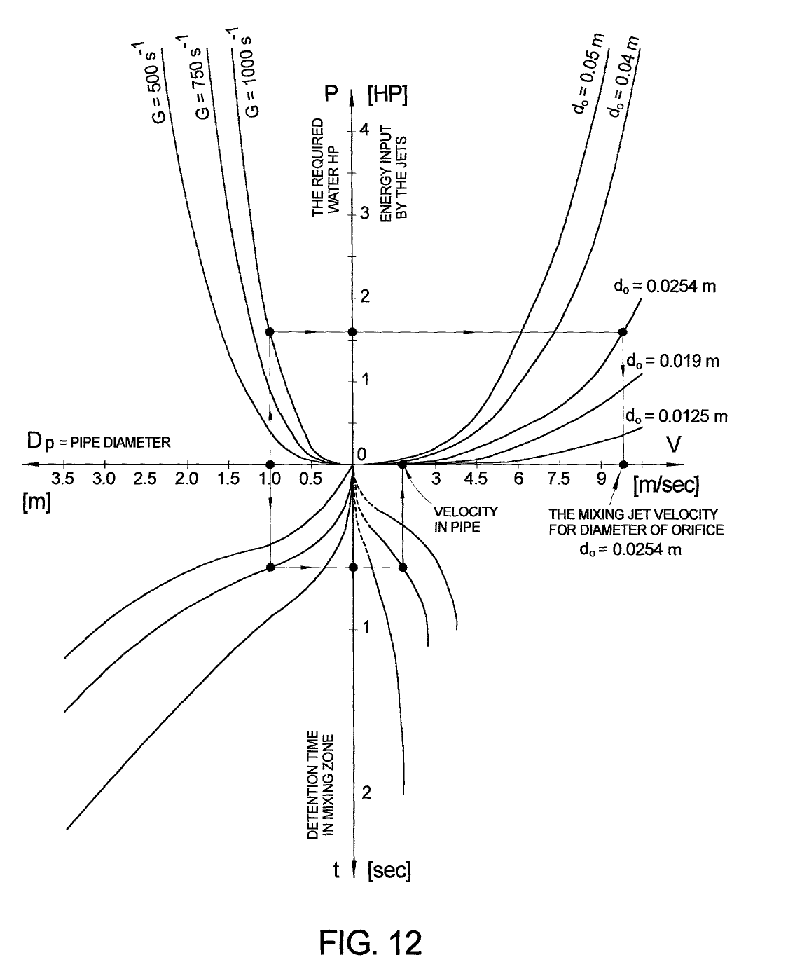

FIG. 12 shows a generalized graph for preliminary evaluation of flash mixing system, for example, for pipe diameter 1 m, velocity gradient 1000 sec⁻¹, orifice diameter 0.0254 m, the mixing jet velocity 9.5 m/sec, velocity in pipe 1.75 m/sec, detention time in mixing zone 0.65 sec, the energy input by the jets is 1.55 hp.

What I claim as my invention is:

1. A hydrodynamical dispersive flash mixing system for attachment to a water treatment plant, a system comprising six pressured water jets and one nozzle for the injection of aluminum sulfate solution, a flash mixer introduced with four installation alternatives, a system also with four connectivity alternatives of the liquid chemical feed system.

2. A flash mixing system as defined in claim 1, wherein:
said mixer obtains an optimal coagulation;
said mixer avoids clogging of pipes and nozzles with aluminum hydroxide scale;
said mixer avoids the impacts of water temperature;
said changes of flow capacity and coagulant dose are controllable.

3. A flash mixing system as defined in claim 1, wherein said the system is very effective, flexible, reliable and cost savings for medium, large, and extra large diameters of influent pipeline.
